(19) United States
(12) Patent Application Publication
(10) Pub. No.: US 2024/0221990 A1
(43) Pub. Date: Jul. 4, 2024

(54) TRANSFORMER

(71) Applicant: Delta Electronics, Inc., Taoyuan City (TW)

(72) Inventors: Ching-Hsien TENG, Taoyuan City (TW); Chun-Ching YEN, Taoyuan City (TW)

(21) Appl. No.: 18/456,186

(22) Filed: Aug. 25, 2023

(30) Foreign Application Priority Data
Dec. 30, 2022 (CN) 202211726510.8

(51) Int. Cl. H01F 27/26; H01F 27/02; H01F 27/30; H01F 27/34

(52) U.S. Cl. CPC H01F 27/263; H01F 27/022; H01F 27/306; H01F 27/346

(57) ABSTRACT

A transformer is provided, including a first magnetic core, a second magnetic core, a first winding assembly, and a second winding assembly. The first magnetic core includes a first base and a first pillar disposed at the center of the first base. The second magnetic core includes a second base and two second pillars disposed on opposite ends of the second base. The second pillars are connected to the second base and extend toward the first base. The first pillar extends toward the second base and is disposed between the second pillars, and the length of the first pillar is substantially the same as the length of each of the second pillars. The first winding assembly surrounds the first pillar. The second winding assembly surrounds the first pillar. The first winding assembly and the second winding assembly are separated from each other.

### CROSS REFERENCE TO RELATED APPLICATIONS

The present application claims priority of China Patent Application No. 202211726510.8, filed Dec. 30, 2022, which is incorporated by reference herein in its entirety.

### BACKGROUND OF THE INVENTION

### Field of the Invention

The application relates in general to a transformer, and in particular, to a transformer that can increase leakage inductance.

### Description of the Related Art

The transformer is one of the most important components in an electronic apparatus. The transformer is primarily used to transform drive voltage from circuits. For example, a power transformer can lower voltage, and step-up transformers in the AC adapter module of a notebook computer can raise the operating voltage from the circuits. Therefore, there are various types of transformers, made for various functions. Most transformers are customized according to the needs of consumers.

Each different transformer usually has a different leakage inductance, based on requirements. When a transformer needs to include a large leakage inductance, the dimensions of the whole transformer is increased accordingly. Therefore, how to address the aforementioned problem has become an important issue.

### BRIEF SUMMARY OF INVENTION

To address the deficiencies of conventional products, an embodiment of the invention provides a transformer, including a first magnetic core, a second magnetic core, a first winding assembly, and a second winding assembly. The first magnetic core includes a first base and a first pillar, and the first pillar is disposed at the center of the first base. The second magnetic core includes a second base and two second pillars, and the second pillars are disposed on opposite ends of the second base. The second pillars are connected to the second base and extend toward the first base. The first pillar extends toward the second base and is disposed between the second pillars, and the length of the first pillar is substantially the same as the length of each of the second pillars. The first winding assembly surrounds the first pillar, and disposed between the first pillar and the second pillars. The second winding assembly surrounds the first pillar, and disposed between the first pillar and the second pillars. The first winding assembly and the second winding assembly are separated from each other.

In some embodiments, an air gap is formed between the first base and the second pillars, an additional air gap is formed between the second base and the first pillar, and the air gap and the additional air gap are disposed on opposite ends of the first pillar. The air gap is from 0.1 millimeter to 0.2 millimeters, and the additional air gap is from 0.1 millimeter to 0.2 millimeters.

In some embodiments, the transformer further comprises a spacing member, disposed between the first winding assembly and the second winding assembly. The spacing member includes phenol formaldehyde resin, copper foil, plastic, tape, or magnetic permeability material.

In some embodiments, the first winding assembly surrounds the first pillar, the spacing member surrounds the first winding assembly, and the second winding assembly surrounds the spacing member.

In some embodiments, the first winding assembly is disposed between the spacing member and the first base, and the second winding assembly is disposed between the spacing member and the second base.

In some embodiments, the first winding assembly is disposed between the second winding assembly and the first base, and the second winding assembly is disposed between the first winding assembly and the second base.

In some embodiments, the transformer further comprises a winding base disposed on the first base, and the first winding assembly and the second winding assembly are disposed between the winding base and the second base. The winding base comprises a plurality of pins, and the first winding assembly or the second winding assembly winds around the pins.

In some embodiments, the transformer further comprises a winding base, and the winding base includes a tubular portion and a planar portion. The tubular portion surrounds the first pillar, and the first winding assembly surrounds the tubular portion. The planar portion is connected to the tubular portion and disposed between the first winding assembly and the second winding assembly.

In some embodiments, the transformer further comprises a spacing member, disposed between the planar portion and the second winding assembly. The spacing member includes phenol formaldehyde resin, copper foil, plastic, tape, or magnetic permeability material.

### BRIEF DESCRIPTION OF DRAWINGS

The invention can be more fully understood by reading the subsequent detailed description and examples with references made to the accompanying drawings, wherein:

FIG. 1 is a schematic diagram of a transformer according to an embodiment of the invention;

FIG. 2 is a cross-sectional view along line A-A in FIG. 1;

FIG. 3 is a schematic diagram of a transformer according to another embodiment of the invention;

FIG. 4 is a schematic diagram of a transformer according to another embodiment of the invention;

FIG. 5 is a cross-sectional view along line B-B in FIG. 4;

FIG. 6 is a schematic diagram of a transformer according to another embodiment of the invention;

FIG. 7 is a schematic diagram of a transformer according to another embodiment of the invention;

FIG. 8 is a schematic diagram of a transformer according to another embodiment of the invention; and

FIG. 9 is a schematic diagram of a transformer according to another embodiment of the invention.

### DETAILED DESCRIPTION OF INVENTION

The making and using of the embodiments of the transformer are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

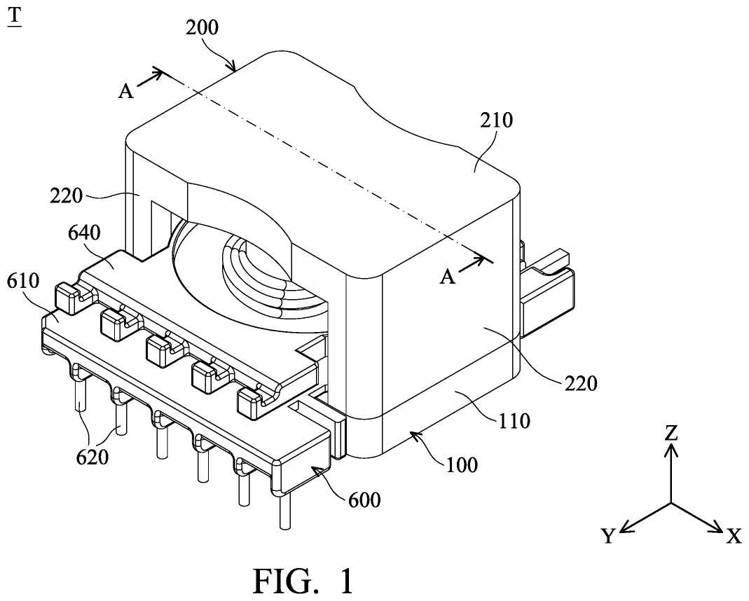

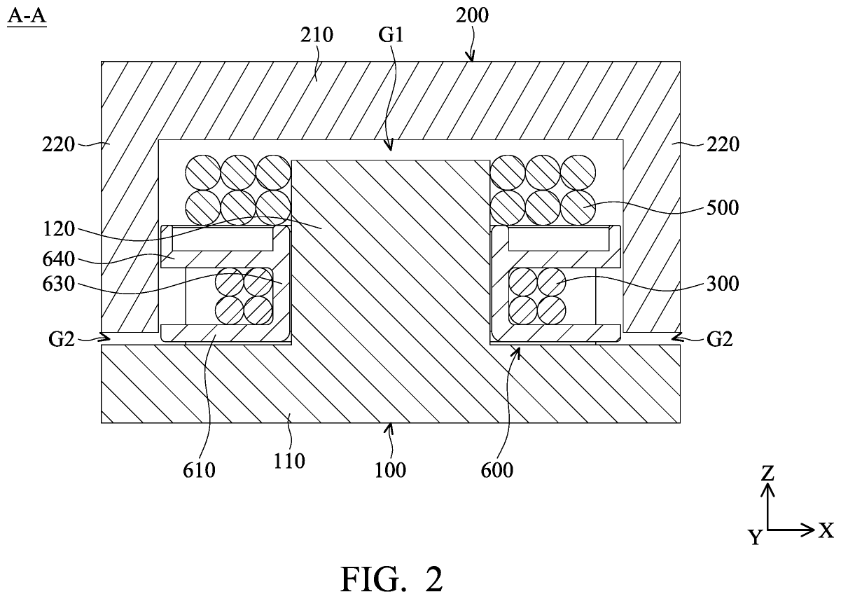

FIG. 1 is a schematic diagram of a transformer T according to an embodiment of the invention, and FIG. 2 is a cross-sectional view along line A-A in FIG. 1. Referring to FIG. 1 and FIG. 2, in the embodiment of the invention, the transformer T primarily includes a first magnetic core 100, a second magnetic core 200, a first winding assembly 300, a second winding assembly 500, and a winding base 600. The first magnetic core 100 and the second magnetic core 200 can be engaged with each other, and the first winding assembly 300, the second winding assembly 500, and the winding base 600 can be disposed between the first magnetic core 100 and the second magnetic core 200.

The first magnetic core 100 substantially has a T-shaped structure. In particular, the first magnetic core 100 includes a first base 110 and a first pillar 120. The first pillar 120 is connected to the first base 110, and the central axis of the first pillar 120 is substantially aligned with the center of the first base 110. In this embodiment, the first pillar 120 is a cylinder, but it is not limited thereto. In some embodiments, the first pillar 120 can be a prism.

The second magnetic core 200 substantially has a U-shaped structure. In particular, the second magnetic core 200 includes a second base 210 and two second pillars 220. The second pillars 220 are connected to the second base 210, and respectively disposed on the opposite ends of the second base 210. When the first magnetic core 100 and the second magnetic core 200 are engaged with each other, the first pillar 120 extends toward the second base 210 of the second magnetic core 200, and the second pillars 220 extend toward the first base 110 of the first magnetic core 100. The user can affix the first pillar 120 to the second base 210 and/or affix the second pillars 220 to the first base 110 by solder or adhesive glue, so as to complete the engagement of the first magnetic core 100 and the second magnetic core 200.

It should be noted that, as shown in FIG. 2, when the first magnetic core 100 and the second magnetic core 200 are engaged with each other, an air gap G1 is formed between the first pillar 120 and the second base 210, and air gaps G2 are formed between the second pillars 220 and the first base 110. Since the air gap G1 and the air gaps G2 are respectively located at the opposite sides of the first pillar 120, the bridge loss when the transformer T is in use can be reduced, and the leakage inductance and the transform efficiency of the transformer T can be increased. In this embodiment, the first pillar 120 and the second pillars 220 substantially have the same length in the Z-axis, and the air gaps G1 and G2 are from 0.1 millimeter to 0.2 millimeters.

The winding base 600 includes a substrate 610, a plurality of pins 620, a tubular portion 630, and a planar portion 640. The tubular portion 630 surrounds the first pillar 120, and the substrate 610 and the planar structure 640 are connected to the tubular portion 630 at the opposite ends. In this embodiment, the substrate 610, the tubular portion 630, and the planar portion 640 can be integrally formed as one piece, and can be made of insulating material. The pins 620 are connected to the substrate 610, and can be made of metal.

The first winding assembly 300 winds around the tubular base 630 of the winding base 600, so the first winding assembly 300 can surround the tubular portion 630 and the first pillar 120. The second winding assembly 500 directly winds around the first pillar 120. It should be noted that, the planar portion 640 of the winding base 600 is disposed between the first winding assembly 300 and the second winding assembly 500, so that the first winding assembly 300 and the second winding assembly 500 can be separated by the planar portion 640.

The end of the first winding assembly 300 and the end of the second winding assembly 500 can wind around different pins 620 of the winding base 600 to connect the external electronic member(s).

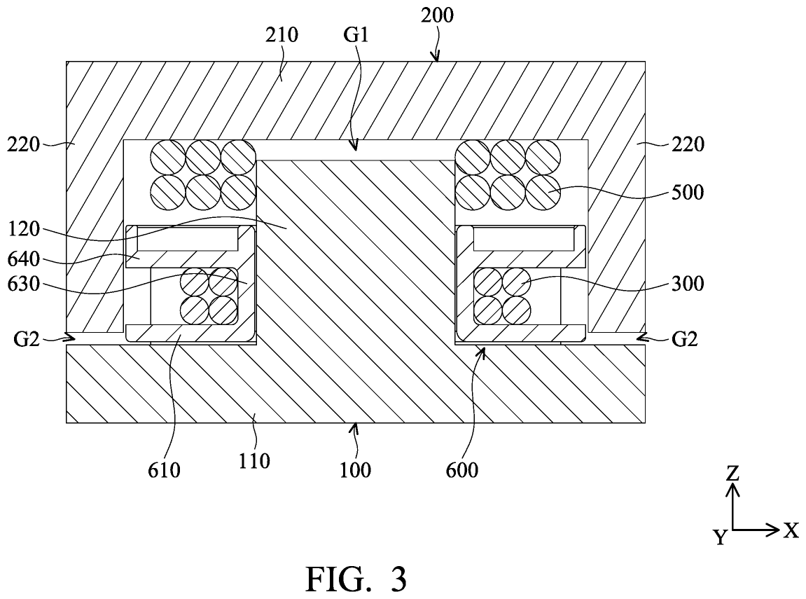

In the aforementioned embodiment, the second winding assembly 500 winds the first pillar 500 and is in contact with the winding base 600, but it is not limited thereto. For example, as shown in FIG. 3, the second winding assembly 500 can be attached on the second magnetic core 200 by adhesive glue and apart from the winding base 600.

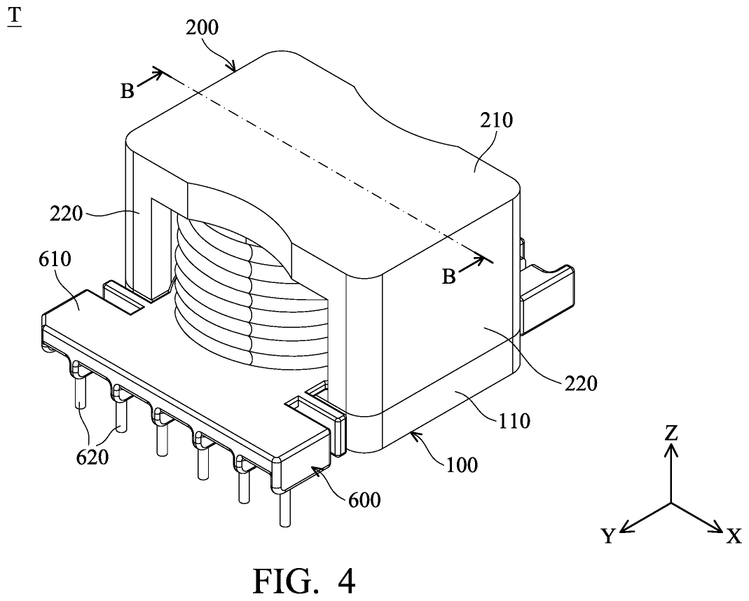

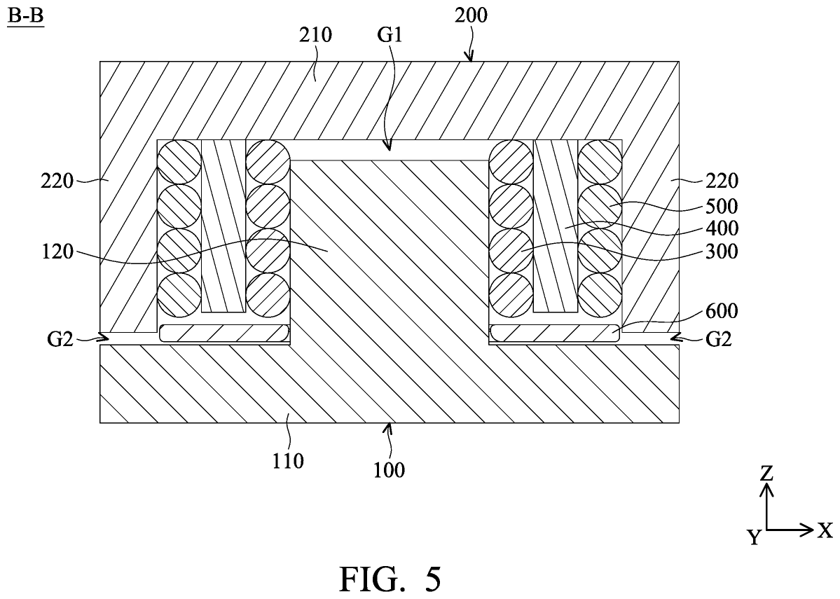

FIG. 4 is a schematic diagram of a transformer T according to another embodiment of the invention, and FIG. 5 is a cross-sectional view along line B-B in FIG. 4. Referring to FIG. 4 and FIG. 5, in this embodiment, the transformer T primarily includes a first magnetic core 100, a second magnetic core 200, a first winding assembly 300, a spacing member 400, a second winding assembly 500, and a winding base 600. The first magnetic core 100 and the second magnetic core 200 can be engaged with each other, and the first winding assembly 300, the spacing member 400, the second winding assembly 500, and the winding base 600 can be disposed between the first magnetic core 100 and the second magnetic core 200. When current flows into the transformer T through the first winding assembly 300, the transformer T can output current with different voltage through the second winding assembly 500 by electromagnetic induction. The transformer T can be applied in the various different electronic apparatuses, such as the power supply, the motherboard, the modem, and etc., but it is not limited thereto.

The first magnetic core 100 substantially has a T-shaped structure. In particular, the first magnetic core 100 includes a first base 110 and a first pillar 120. The first pillar 120 is connected to the first base 110, and the central axis of the first pillar 120 is substantially aligned with the center of the first base 110. In this embodiment, the first pillar 120 is a cylinder, but it is not limited thereto. In some embodiments, the first pillar 120 can be a prism.

The second magnetic core 200 substantially has a U-shaped structure. In particular, the second magnetic core 200 includes a second base 210 and two second pillars 220. The second pillars 220 are connected to the second base 210, and respectively disposed on the opposite ends of the second base 210. When the first magnetic core 100 and the second magnetic core 200 are engaged with each other, the first pillar 120 extends toward the second base 210 of the second magnetic core 200, and the second pillars 220 extend toward the first base 110 of the first magnetic core 100. The user can affix the first pillar 120 to the second base 210 and/or affix the second pillars 220 to the first base 110 by solder or adhesive glue, so as to complete the engagement of the first magnetic core 100 and the second magnetic core 200.

It should be noted that, as shown in FIG. 5, when the first magnetic core 100 and the second magnetic core 200 are engaged with each other, an air gap G1 is formed between the first pillar 120 and the second base 210, and air gaps G2 are formed between the second pillars 220 and the first base 110. Since the air gap G1 and the air gaps G2 are respectively located at the opposite sides of the first pillar 120, the bridge loss when the transformer T is in use can be reduced, and the leakage inductance and the transform efficiency of the transformer T can be increased. In this embodiment, the first pillar 120 and the second pillars 220 substantially have the same length in the Z-axis, and the air gaps G1 and G2 are from 0.1 millimeter to 0.2 millimeters.

The first winding assembly 300 and the second winding assembly 500 surround the first pillar 120, and the spacing member 400 is disposed between the first winding assembly 300 and the second winding assembly 500 to separate them. In detail, the first winding assembly 300 can wind around the first pillar 120, the spacing member 400 can surround the first winding assembly 300, and the second winding assembly 500 can wind around the spacing member 400.

Each of the first winding assembly 300 and the second winding assembly 500 can include one or more coils, one or more metal plates, or other electrically conductive member. The spacing member 400 can include phenol formaldehyde resin (Bakelite), copper foil, plastic, tape, or magnetic permeability material, but it is not limited thereto. The spacing member 400 can be configured to insulate the first winding assembly 300 from the second winding assembly 500 and/or enhance the magnetic field when the transformer T is in use.

The winding base 600 is disposed on the first base 110, and the first winding assembly 300, the spacing member 400, and the second winding assembly 500 are disposed between the winding base 600 and the second base 210. In this embodiment, the winding base 600 includes a substrate 610 and a plurality of pins 620. The substrate 610 is disposed on the first base 110, and the substrate 610 can be made of insulating material. The pins 620 are connected to the substrate 610, and the end of the first winding assembly 300 and the end of the second winding assembly 500 can wind around different pins 620 to connect the external electronic member(s).

In some embodiments, the winding base 600 can be omitted to reduce the whole volume of the transformer T.

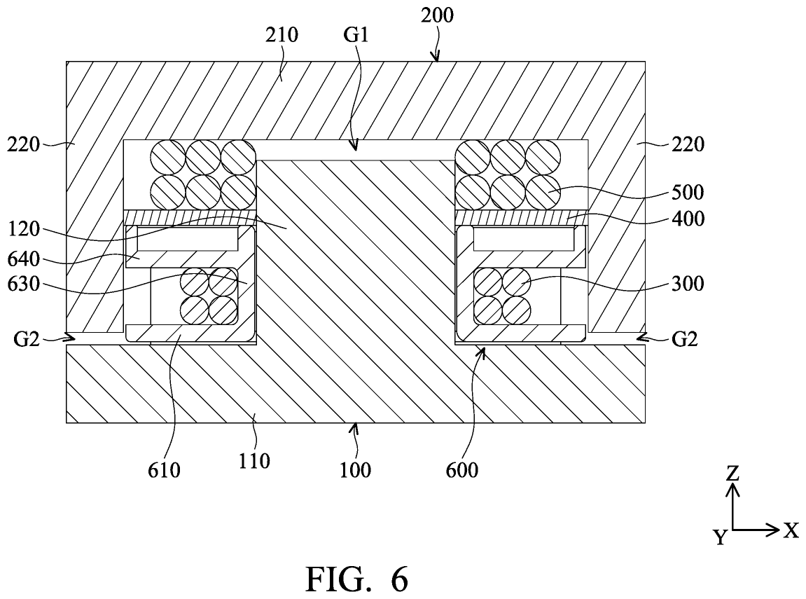

Referring to FIG. 6, in another embodiment of the invention, the transformer T primarily includes a first magnetic core 100, a second magnetic core 200, a first winding assembly 300, a spacing member 400, a second winding assembly 500, and a winding base 600. The first magnetic core 100, the second magnetic core 200, the first winding assembly 300, the second winding assembly 500, and the winding base 600 are the same as that in the embodiment of FIGS. 1 and 2, so that the features thereof are not repeated in the interest of brevity.

The spacing member 400 can be disposed between the planar portion 640 of the winding base 600 and the second winding assembly 500. Therefore, the first winding assembly 300 and the second winding assembly 500 are separated by the planar portion 640 of the winding base 600, and further separated by the spacing member 400. For example, the spacing member 400 can include phenol formaldehyde resin (Bakelite), copper foil, plastic, tape, or magnetic permeability material, but it is not limited thereto. The spacing member 400 is configured to insulate the first winding assembly 300 from the second winding assembly 500 and/or enhance the magnetic field when the transformer T is in use.

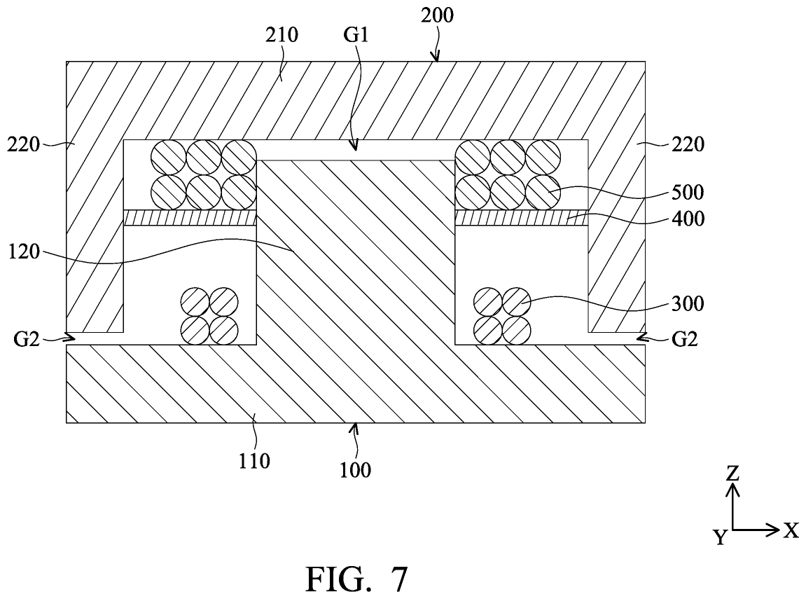

Referring to FIG. 7, in another embodiment of the invention, the transformer T primarily includes a first magnetic core 100, a second magnetic core 200, a first winding assembly 300, a spacing member 400, and a second winding assembly 500. The first magnetic core 100, the second magnetic core 200, the first winding assembly 300, the spacing member 400, and the second winding assembly 500 are the same as that in the embodiment of FIG. 6, so that the features thereof are not repeated in the interest of brevity.

In this embodiment, the winding base is omitted, so that the winding spaces of the first winding assembly 300 and the second winding assembly 500 are increased further, and the leakage inductance and the transform efficiency of the transformer T can therefore be increased.

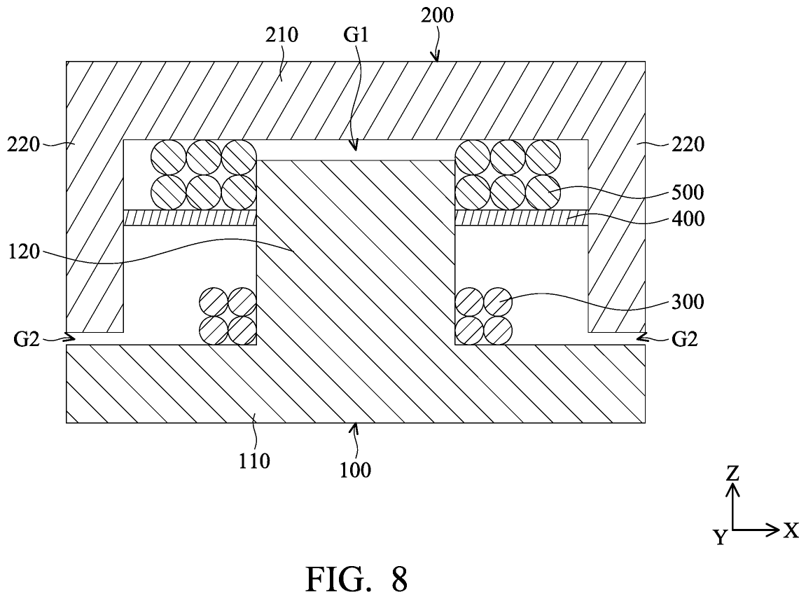

In the embodiment of FIG. 7, the first winding assembly 300 is disposed on the first base 110 and separated from the first pillar 120, but it is not limited thereto. For example, as shown in FIG. 8, the first winding assembly 300 can be in contact with the first pillar 120.

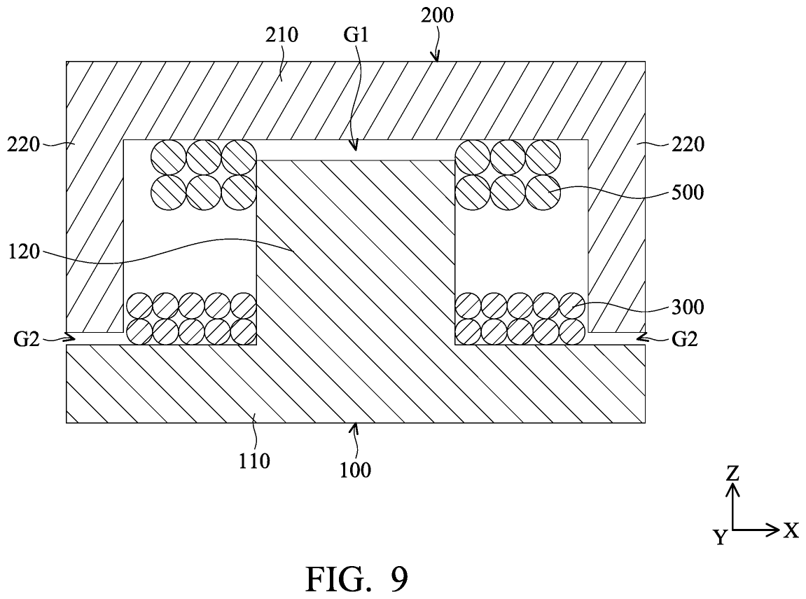

Referring to FIG. 9, in another embodiment of the invention, the transformer T primarily includes a first magnetic core 100, a second magnetic core 200, a first winding assembly 300, and a second winding assembly 500. The first magnetic core 100, the second magnetic core 200, the first winding assembly 300, and the second winding assembly 500 are the same as that in the embodiment of FIGS. 1 and 2, so that the features thereof are not repeated in the interest of brevity. The second winding assembly 500 can be attached on the second magnetic core 200 by adhesive glue.

In this embodiment, the spacing member and the winding base are omitted, so that the winding spaces of the first winding assembly 300 and the second winding assembly 500 are increased further, and the leakage inductance and the transform efficiency of the transformer T can therefore be increased. Alternatively, the whole volume of the transformer T can be reduced, so as to miniaturize the transformer T.

In summary, an embodiment of the invention provides a transformer, including a first magnetic core, a second magnetic core, a first winding assembly, and a second winding assembly. The first magnetic core includes a first base and a first pillar, and the first pillar is disposed at the center of the first base. The second magnetic core includes a second base and two second pillars, and the second pillars are disposed on opposite ends of the second base. The second pillars are connected to the second base and extend toward the first base. The first pillar extends toward the second base and is disposed between the second pillars, and the length of the first pillar is substantially the same as the length of each of the second pillars. The first winding assembly surrounds the first pillar, and disposed between the first pillar and the second pillars. The second winding assembly surrounds the first pillar, and disposed between the first pillar and the second pillars. The first winding assembly and the second winding assembly are separated from each other.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements. While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A transformer, comprising:
a first magnetic core, comprising a first base and a first pillar, wherein the first pillar is disposed at a center of the first base;
a second magnetic core, comprising a second base and two second pillars, wherein the second pillars are respectively formed on opposite ends of the second base, the second pillars extend toward the first base, the first pillar extends toward the second base and is disposed between the second pillars, and a length of the first pillar is substantially the same as a length of each of the second pillars;
a first winding assembly, surrounding the first pillar and disposed between the first pillar and the second pillars; and
a second winding assembly, surrounding the first pillar and disposed between the first pillar and the second pillars, wherein the first winding assembly and the second winding assembly are separated from each other.

2. The transformer as claimed in claim 1, wherein an air gap is formed between the first base and the second pillars, an additional air gap is formed between the second base and the first pillar, and the air gap and the additional air gap are disposed on opposite ends of the first pillar.

3. The transformer as claimed in claim 1, wherein the first winding assembly is disposed between the second winding assembly and the first base, and the second winding assembly is disposed between the first winding assembly and the second base.

4. The transformer as claimed in claim 3, wherein the transformer further comprises a winding base disposed on the first base, and the first winding assembly and the second winding assembly are disposed between the winding base and the second base.

5. The transformer as claimed in claim 4, wherein the winding base comprises a plurality of pins, and the first winding assembly or the second winding assembly winds around the pins.

6. The transformer as claimed in claim 1, wherein the transformer further comprises a spacing member, disposed between the first winding assembly and the second winding assembly.

7. The transformer as claimed in claim 6, wherein the first winding assembly surrounds the first pillar, the spacing member surrounds the first winding assembly, and the second winding assembly surrounds the spacing member.

8. The transformer as claimed in claim 6, wherein the first winding assembly is disposed between the spacing member and the first base, and the second winding assembly is disposed between the spacing member and the second base.

9. The transformer as claimed in claim 6, wherein the spacing member includes phenol formaldehyde resin, copper foil, plastic, tape, or magnetic permeability material.

10. The transformer as claimed in claim 1, wherein the transformer further comprises a winding base, and the winding base comprises:
a tubular portion, surrounding the first pillar, wherein the first winding assembly surrounds the tubular portion; and
a planar portion, connected to the tubular portion and disposed between the first winding assembly and the second winding assembly.

11. The transformer as claimed in claim 10, wherein the transformer further comprises a spacing member, disposed between the planar portion and the second winding assembly.

12. The transformer as claimed in claim 11, wherein the spacing member includes phenol formaldehyde resin, copper foil, plastic, tape, or magnetic permeability material.
